(19) United States
(12) Patent Application Publication
(10) Pub. No.: US 2026/0094405 A1
(43) Pub. Date: Apr. 2, 2026

(54) METHOD FOR GROWING A REGION IN A MEDICAL IMAGE

(71) Applicant: Siemens Healthineers AG, Forchheim (DE)

(72) Inventors: Halid Yerebakan, Carmel, IN (US); Mohammad Abdishektaei, Charlottesville, VA (US); Yoshihisa Shinagawa, Downingtown, PA (US); Gerardo Hermosillo Valadez, West Chester, PA (US); Mahesh Ranganath, Malvern, PA (US)

(21) Appl. No.: 19/303,460

(22) Filed: Aug. 19, 2025

(30) Foreign Application Priority Data
Sep. 30, 2024 (DE) 10 2024 128 228.2

(51) Int. Cl. G06V 10/26; G06V 10/32; G06V 10/40; G06V 10/75; G06V 10/764; G06V 10/82; G06V 20/50

(52) U.S. Cl. CPC G06V 10/267; G06V 10/32; G06V 10/40; G06V 10/759; G06V 10/764; G06V 20/50; G06V 10/82; G06V 2201/03

(57) ABSTRACT

A computer-implemented method for growing a region in a medical image. The method comprises receiving a medical image, receiving a seed point in the medical image, and extracting first features from the medical image. A trained first machine learning algorithm is applied to the extracted first features to obtain a classification of tissue at the seed point. A trained second machine learning algorithm is applied to the extracted first features to obtain a first region of confidence relative to the seed point. The first region of confidence is a region in which the tissue is expected to be the same as at the seed point. In a graphical user interface, a region in the medical image is grown from the seed point to include the first region of confidence.

### CROSS-REFERENCE TO RELATED APPLICATION

This application claims the benefit of priority from German Patent Application No. 10 2024 128 228.2, filed on Sep. 30, 2024, the contents of which are incorporated by reference.

### TECHNICAL FIELD

The present framework relates to growing a region in a medical image.

### BACKGROUND

The field of medical imaging has experienced rapid advancements, providing healthcare professionals with sophisticated tools for diagnosing and treating various conditions. Among these tools, segmentation techniques play a pivotal role in extracting meaningful information from complex imaging data. Region growing, a fundamental method for image segmentation, has demonstrated significant potential in delineating anatomical structures and pathological regions. For example, region growing allows radiologists to segment and visualize different anatomical structures interactively.

Region growing begins with the selection of one or more seed points, which are typically chosen manually by a radiologist or automatically by an algorithm. These seed points are situated in areas of the image that are known or suspected to belong to the region of interest, such as a tumor or an organ.

Once the seed points are established, the region growing algorithm initiates the segmentation process by examining the neighboring pixels or voxels of each seed point. The core idea is to expand the region from the seed point based on certain criteria, such as intensity, texture, or other relevant features. Each neighboring pixel is assessed to determine whether it should be included in the growing region. This inclusion is typically guided by similarity measures, ensuring that only those pixels or voxels that are similar to the seed point (or to the pixels already included in the region) are added.

The similarity criteria can be based on various factors, with the most common being intensity values. For instance, if the seed point is located within a tumor, the algorithm will look for neighboring pixels that have similar intensity values to those of the seed point. If the pixel's intensity falls within a specified range around the seed point's intensity, it is added to the region. This process continues iteratively, with the algorithm expanding outward from the seed point to include all neighboring pixels that meet the criteria.

To ensure the region grows in a controlled and meaningful way, the algorithm often incorporates additional stopping criteria. These may include predefined thresholds for the maximum allowable size of the region, or stopping when no further pixels meet the inclusion criteria. The expansion process stops once the algorithm reaches the boundary of the region where pixels no longer conform to the similarity criteria, or when all potential neighboring pixels have been examined.

Region growing can also be adapted to handle different types of medical images and varying conditions. For instance, in multi-modal imaging, where images from different sources or techniques are combined, the algorithm might incorporate multi-scale analysis or use more complex feature sets to improve segmentation accuracy.

Despite its utility, conventional region-growing algorithms face limitations in accuracy, computational efficiency, and adaptability to diverse imaging scenarios.

### SUMMARY

One aspect of the present framework relates to a computer-implemented method for growing a region in a medical image. The method comprises receiving a medical image, receiving a seed point in the medical image, and extracting first features from the medical image. A trained first machine learning algorithm is applied to the extracted first features to obtain a classification of tissue at the seed point. A trained second machine learning algorithm is applied to the extracted first features to obtain a first region of confidence relative to the seed point. The first region of confidence is a region in which the tissue is expected to be the same as at the seed point. In a graphical user interface, a region in the medical image is grown from the seed point to include the first region of confidence.

### BRIEF DESCRIPTION OF THE DRAWINGS

FIG. 1 illustrates a block diagram of a client-server architecture embodying a system for growing a region in a medical image;

FIG. 2 illustrates a block diagram of a data processing system embodying a device for growing a region in a medical image;

FIG. 3 illustrates a flowchart of an embodiment of a computer-implemented method for growing a region in a medical image;

FIG. 4 illustrates a medical image showing a descriptor according to an embodiment;

FIG. 5 illustrates voxels in the medical image of FIG. 4;

FIG. 6 illustrates a close-up of a blood vessel of FIG. 4 partially grown with a region;

FIG. 7 illustrates a machine learning model;

FIG. 8 illustrates the region fully grown over the blood vessel of FIGS. 4 and 6;

FIG. 9 illustrates a flowchart of an embodiment of a computer-implemented method for training the machine learning model of FIG. 7;

FIG. 10 illustrates a medical image used during the training of the machine learning model of FIG. 7; and

FIG. 11 illustrates a block-by-block region growing according to an embodiment.

Hereinafter, embodiments for carrying out the present invention are described in detail. The various embodiments are described with reference to the drawings, wherein like reference numerals are used to refer to like elements throughout. In the following description, for purpose of explanation, numerous specific details are set forth in order to provide a thorough understanding of one or more embodiments. It may be evident that such embodiments may be practiced without these specific details.

### DETAILED DESCRIPTION

It is one object of the present framework to provide an improved approach towards region growing in the analysis of medical image data.

According to a first aspect, there is provided a computer-implemented method for growing a region in a medical image, the method comprising:
1a) receiving a medical image;
1b) receiving a seed point in the medical image;
1c) extracting first features from the medical image;
1d) applying a trained first machine learning algorithm to the extracted first features to obtain a classification of tissue at the seed point;
1e) applying a trained second machine learning algorithm to the extracted first features to obtain a first region of confidence relative to the seed point, the first region of confidence being a region in which the tissue is expected to be the same as at the seed point; and
1f) growing, in a graphical user interface, a region in the medical image from the seed point to include the first region of confidence.

Advantageously, growth speed is decided without manual selection, taking into account the nature of the region of interest. The segmentation mask may thus grow faster in larger, uniform regions (i.e., with high confidence) while allowing slow down in smaller regions requiring high resolution (i.e., with low confidence). For example, in some cases, the region of interest or target is a small structure such as a vessel. Thus, highest resolution is important. However, in some other regions the target structure occupies a larger volume such as the aorta. In this case, a low resolution may be acceptable, thus increasing processing speed.

The medical image may comprise an organ or portion thereof, the organ or portion including the tissue mentioned above. An organ is to be understood as a collection of tissue joined in a structural unit to serve a common function. The organ may be a human organ. The organ may be any one of the following, for example: intestines, skeleton, kidneys, gall bladder, liver, muscles, arteries, heart, larynx, pharynx, brain, lymph nodes, lungs, spleen, bone or bone marrow, stomach, veins, pancreas, bladder or any blood vessel. The organ or portion or tissue may include or be affected by a tumor or other disease.

The medical image may be captured by and received from a medical imaging unit, the medical imaging unit may include, for example, but not limited to, a magnetic resonance imaging device, a computer tomography device, an X-ray imaging device, an ultrasound imaging device, etc. The medical image may be three-dimensional (3D) and/or related to a volume. The 3D medical image may be made up of a number of slices, i.e., 2D (two-dimensional) medical images. The 2D medical images may be captured by and received from the medical imaging unit mentioned above. The 2D medical images may then be assembled to form the volumetric medical image. On the other hand, the medical image captured by and received from the medical imaging unit may be 2D only.

Herein, a voxel represents a value in three-dimensional space, whereas a pixel represents a value in two-dimensional space. The pixels or voxels may or may not have their position, i.e., their coordinates, explicitly encoded with their values. Instead, the position of a pixel or voxel may be inferred based upon its position relative to other pixels or voxels (i.e., is positioned in the data structure that makes up a single 2D or 3D (volumetric) image). The voxels may be arranged on a 3D grid, the pixels on a 2D grid. The 2D medical image may, for example, be in the form of an array of pixels. The volumetric medical image may comprise an array of voxels. The pixels of a number of 2D medical images making up a volumetric medica image are also presently referred to as voxels. The pixels or voxels may be representative of intensity, absorption or other parameters as a function of a three-dimensional position, and may, for example, be obtained by a suitable processing of measurement signals obtained by one or more of the above-mentioned medical imaging units.

In one embodiment, a robot, (e.g., computed tomographic or CT, magnetic resonance or MR) scanner or other device or machine is controlled depending on the grown region. The robot may be configured for operating on a patient's body, for example. In particular, a robot (e.g., an operating instrument thereof such as a scalpel) or scanner movement may be controlled depending on the grown region.

In medical imaging, a descriptor refers to a quantifiable feature or characteristic that represents specific aspects of an image, such as texture, shape, intensity, or edges. Descriptors are used to capture key details in the image that can aid in analysis, classification, or comparison. These features help in tasks like identifying organs, detecting abnormalities, segmenting regions, and supporting diagnosis. Descriptors can be low-level (e.g., pixel intensity, gradients) or high-level (e.g., shape and texture patterns). Common examples include histograms of pixel intensities, texture descriptors like Gabor filters, or more advanced feature representations learned through machine learning models like Convolutional Neural Networks (CNNs).

For example, the first region of confidence is a volume around the seed point and/or defined by a radius from the seed point. The second region of confidence may be a volume around the second point and/or may be defined by a radius from the second point.

According to an embodiment, there is provided a third machine learning algorithm to extract the features (e.g., first and/or second features) from the medical image. For example, the first, second and third machine learning algorithms may be implemented as one (a single) or more neural networks. Preferably, the first and third machine learning algorithms used in step 1d) and 1e) (and step 2c)) have been trained prior to step 1a) in a supervised manner. The third machine learning algorithm used in step 1c) (and 2b)) has been trained prior to step 1a) in a self-supervised manner, preferably.

A “neural network” herein refers to an artificial neural network which is built up like a biological neural net, e.g., a human brain. In particular, an artificial neural network comprises an input layer and an output layer. It may further comprise a plurality of layers between the input and output layer. Each layer comprises at least one, preferably a plurality of nodes. Each node may be understood as a biological processing unit, e.g., a neuron. In other words, each neuron corresponds to an operation applied to input data. Nodes of one layer may be interconnected by edges or connections to nodes of other layers, in particular, by directed edges or connections. These edges or connections define the data flow between the nodes of the network. In particular, the edges or connections are equipped with a parameter, wherein the parameter is often denoted as “weight”. This parameter can regulate the importance of the output of a first node to the input of a second node, wherein the first node and the second node are connected by an edge.

Neural networks can be trained. “Self-supervised” learning (SSL) is a paradigm in machine learning where a model is trained on a task using the data itself to generate supervisory signals, rather than relying on external labels provided by humans. In the context of neural networks, self-supervised learning aims to leverage inherent structures or relationships within the input data to create meaningful training signals. SSL tasks are designed so that solving it requires capturing essential features or relationships in the data. The input data is typically augmented or transformed in a way that creates pairs of related samples. One sample serves as the input, and the other is used to formulate the supervisory signal. This augmentation can involve introducing noise, cropping, rotation, or other transformations. “Supervised” learning of a neural network is based on known pairs of input and output values, wherein the known input values are used as inputs of the neural network, and wherein the corresponding output value of the neural network is compared to the corresponding known output value. The artificial neural network independently learns and adapts the weights for the individual nodes until the output values of the last network layer sufficiently correspond to the known output values according to the training data. For convolutional neural networks, this technique is also called “deep learning”.

For example, the first and second machine learning algorithm are implemented as two neural network heads following a feature extraction neural network backbone. The head of a neural network is usually made up of task-specific layers that are designed to produce the final prediction or inference based on the information extracted previously, e.g. in the feature extraction layers of the backbone. On the other hand, three separate neural networks may be used as the first, second and third machine learning algorithm.

The graphical user interface (GUI) may be a screen, smart glasses, a beamer, a hologram projector, etc., or include other means of 2D or 3D visualization. The region may be a region in the medical image. The region may be grown by adding pixels on a screen (or other 2D or 3D GUI) to an existing point (e.g., seed point) or grown region. This addition can be made visual in different ways. For example, all added pixels are changed to the same color, brightness, etc. as the existing point or region. Alternatively, a bounding line (e.g., without changing the colors of the pixels included therein) is expanded to include a larger region.

In step 1f), growing of the region may occur within the data only, i.e., voxels in the image are added to the region by changing or adding certain meta data to those voxels. In this case, “in a graphical user interface” is an optional feature in step 1f).

According to an embodiment, the method further comprises:
2a) identifying at least one second point in the medical image depending on the obtained first region of confidence;
2b) extracting at least second features from the medical image;
2c) applying the trained second machine learning algorithm to the extracted at least second features to obtain a second region of confidence relative to the at least one second point, the second region of confidence being a region in which the tissue is expected to be the same as at the at least one second point; and
2d) growing, in the graphical user interface, the region further to include the second region of confidence.

In this way, the region is grown further to include, in addition to the seed point and the first region of confidence, the second region of confidence, i.e., all voxels within said regions. The first and second region may or may not overlap (in 2D or 3D).

The method may further comprise: applying the trained first machine learning algorithm to the extracted second features to obtain a classification of tissue at the at least one second point; and proceeding to step 2c) depending on the classification of tissue at the at least one second point.

Advantageously, the method may stop when it finds that that tissue at the second point is different from seed point.

According to an embodiment, the first region and second region of confidence are different in size.

In this way, the speed at which the region grows can be adjusted in an easy manner.

According to an embodiment, the method further comprises in steps 1e) and/or 2c):
comparing the first and/or second region of confidence to a predefined threshold value; and
limiting the first and/or second region of confidence to the predefined threshold value depending on the comparison.

For example, in this manner too much deviation is prevented in case of noisy input data (within the medical image).

According to a further embodiment,
the at least one second point lies within the first region of confidence; or
in step 2b) at least four or six second points are identified, wherein, preferably, each second point lies within the first region of confidence.

Thus, it may not be necessary to evaluate the tissue at the second point: If the second point lies within the first region of confidence, it can be reasonably expected that the tissue at the second point is the same as at the first point.

Extending the method to four points (2D) or six points (3D) allows the region to grow in all directions.

According to a further aspect there is provided a computer-implemented method for training the first and second machine learning algorithm of the first aspect prior to step 1d), the method comprising:
6a) receiving a medical image;
6b) extracting features from the medical image;
6c) applying a first machine learning algorithm to the extracted features to obtain a classification of tissue at a first point in the medical image, comparing the obtained classification to a first ground truth, and updating the first machine learning algorithm depending on the comparison;
6d) applying a second machine learning algorithm to the extracted features to obtain a region of confidence relative to the first point, the region of confidence being a region in which the tissue is expected to be the same as at the first point, comparing the region of confidence to a second ground truth, and updating the second machine learning algorithm depending on the comparison;
6e) repeating steps 6b) to 6d) for N−1 points in the medical image, with N designating a total number of predefined points in the medical image.

Thus, steps 6c) and 6d) use supervised learning to train the respective machine learning algorithms to classify the tissue and to determine the region of confidence.

According to an embodiment, the first and/or second ground truth is determined by applying a segmentation machine learning algorithm to the medical image or the extracted features.

Thus, the ground truth data may be prepared efficiently in an autonomous manner (without human intervention). Segmentation returns a label for every voxel within the medical image or medical data.

According to an embodiment, the second ground truth is determined by identifying, through segmentation, a number or volume of pixels or voxels representing the same tissue as at the first or Nth point.

Once selected or all voxels within the medical image have been labelled (first ground truth) using the segmentation machine learning algorithm, radii of the regions of confidence may be determined using digital measuring tools (automated or manually) to provide the second ground truth, for example.

According to a further embodiment, the extracted features used in steps 6c) and 6d) are independent samples of data, the samples, preferably, including a unique descriptor, respectively.

In this way, the classification of the tissue becomes independent from the prediction of the region of confidence. Resolution (i.e. the distance of the second point from the seed point and the distance of third points from the second point) can thus be changed as needed.

According to an embodiment, extracting the features from the medical image comprises:
sampling pixels or voxels from the medical image, wherein at least one voxel is skipped between two sampled pixels or voxels;
sampling pixels or voxels in a sparse and/or random manner; and/or
sampling the pixels or voxels with a sampling rate per unit length, area or volume which decreases with a distance of the respective pixel or voxel from the seed point, first point, second point or Nth point, wherein, preferably, the sampling rate decreases at a non-linear rate, in particular at the rate of an exponential, logarithmic or power function.

Sampling of the pixels or voxels may be done by reading from a data file, a database or an array comprising the pixels or voxels. Sampling of the pixels or voxels can be done sequentially or in parallel (for example when multiple pixels voxels are read at the same time). At least one voxel is skipped between two sampled voxels. This is to say that, when looking at all the pixels or voxels of the medical image in their two- or three-dimensional relationship, at least one voxel between two sampled voxels is not sampled. For example, the medical image may comprise a first, second and third voxel arranged in the same row or column. In this case, only the first and third voxel are sampled, the second voxel is not sampled. It may be provided that, first, the first voxel and then the third voxel is sampled. Alternatively, the first and third voxel are sampled in parallel. The sampled voxels may be saved in memory.

“Sparse” is to be understood as, when having regard to the total number of pixels or voxels making up the medical image, only few pixels or voxels are used in sparse sampling. In particular, “sparse” is to say that less than 50% or less than 20% or even less than 10% of the total number of voxels of the medical image are sampled.

“Random” is to say that the sampled pixels or voxels do not follow a regular pattern. In some embodiments, a random number generator or pseudorandom number generator may be used to select the voxels sampled.

By sampling with a sampling rate which decreases per unit length a field of view is obtained, which still focuses on the point of interest (seed point or second point, etc.), but at the same time also takes into account information a distance away from the point of interest.

According to a further embodiment, extracting the features from the medical image comprises oversampling a region of interest, in particular including a tissue identified prior to step 6b).

In this way, the training data is enriched with more positive samples (“blood vessel”). This is especially useful when the relevant tissue makes up only a small portion of the training images used.

According to a further embodiment, in step 1d), 1e), 6c) and/or 6d) the extracted features, first extracted features and/or second extracted features are projected into a fixed dimension to obtain projected features, wherein, preferably, the projected features are normalized and/or linearized to obtain normalized and/or linearized features, wherein, preferably, the normalized and/or linearized features are added to the projected features to obtain resulting features.

This represents one way of effective feature extraction, prior to applying the first and/or second head to the resulting features.

According to a further aspect, there is provided a device for growing a region in a medical image, the device comprising:
one or more processing units;
a first receiving unit which is configured to receive a medical image captured by a medical imaging unit;
a second receiving unit which is configured to receive a seed point within the medical image; and
a memory coupled to the one or more processing units, the memory comprising a module configured to perform the method steps as described above.

According to a further aspect, there is provided a system for growing a region in a medical image, the system comprising:
a medical imaging unit; and
the device as described above.

According to a further aspect, there is provided a computer program product comprising machine readable instructions that when executed by one or more processing units cause the one or more processing units to perform method steps as described above.

A computer program product, such as a computer program means, may be embodied as a memory card, USB stick, CD-ROM, DVD or as a file which may be downloaded from a server in a network. For example, such a file may be provided by transferring the file comprising the computer program product from a wireless communication network.

The features, advantages and embodiments described with respect to the first aspect equally applies to the further aspects, and vice versa.

“A” is to be understood as non-limiting to a single element. Rather, one or more elements may be provided, if not explicitly stated otherwise. Further, “a”, “b” etc. in steps a), step b) etc. is not defining a specific order. Rather, the steps may be interchanged as deemed fit by the skilled person.

The use of “first”, “second”, etc. element herein merely serves as a means to refer to the various elements. The “first”, “second”, etc. element may be the same or different elements, except where there is an indication to the contrary. Also, it is permissible to change these references: e.g., the “third” may be changed to the “second”, etc. Also, the presence of a “first” element does not require a “second” element to be present. Even more, the presence of a “first” element and a “third” element does not require a “second” element to be present.

Where it says “based on” herein, it can also be phrased “depending on” or “as a function of”.

Further possible implementations or alternative solutions of the invention also encompass combinations—that are not explicitly mentioned herein—of features described above or below with regard to the embodiments. The person skilled in the art may also add individual or isolated aspects and features to the most basic form of the invention.

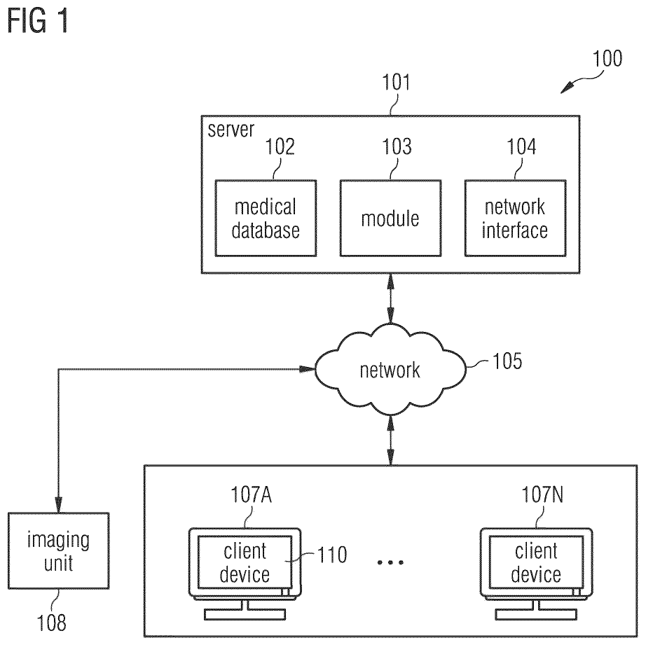

FIG. 1 provides an illustration of a block diagram of a client-server architecture embodying a system for growing a region in a medical image. The client-server architecture 100 comprises a server 101 and a plurality of client devices 107A-N. Each of the client devices 107A-N is connected to the server 101 via a network 105, for example, local area network (LAN), wide area network (WAN), WiFi, etc. In one embodiment, the server 101 is deployed in a cloud computing environment. As used herein, “cloud computing environment” refers to a processing environment comprising configurable computing physical and logical resources, for example, networks, servers, storage, applications, services, etc., and data distributed over the network 105, for example, the internet. The cloud computing environment provides on-demand network access to a shared pool of the configurable computing physical and logical resources. The server 101 may include a medical database 102 that comprises medical images related to a plurality of patients that is maintained by a healthcare service provider. In an embodiment, the medical database 102 comprises medical images captured by an imaging unit 108. The server 101 may include a module 103 that is configured to perform region growing as described hereinafter.

The client devices 107A-N are user devices, used by users, for example, medical personnel such as a radiologist, pathologist, physician, etc. In an embodiment, the user device 107A-N may be used by the user to receive volumetric (3D) or 2D medical images associated with the patient. The data can be accessed by the user via a graphical user interface of an end user web application on the user device 107A-N. In another embodiment, a request may be sent to the server 101 to access the medical images associated with the patient via the network 105.

The imaging unit 108 may be connected to the server 101 through the network 105. The imaging unit 108 may be a medical imaging unit 108 capable of acquiring a plurality of 2D or volumetric medical images. The medical imaging unit 108 may be, for example, a scanner unit such as a magnetic resonance imaging unit, computed tomography imaging unit, an X-ray fluoroscopy imaging unit, an ultrasound imaging unit, etc.

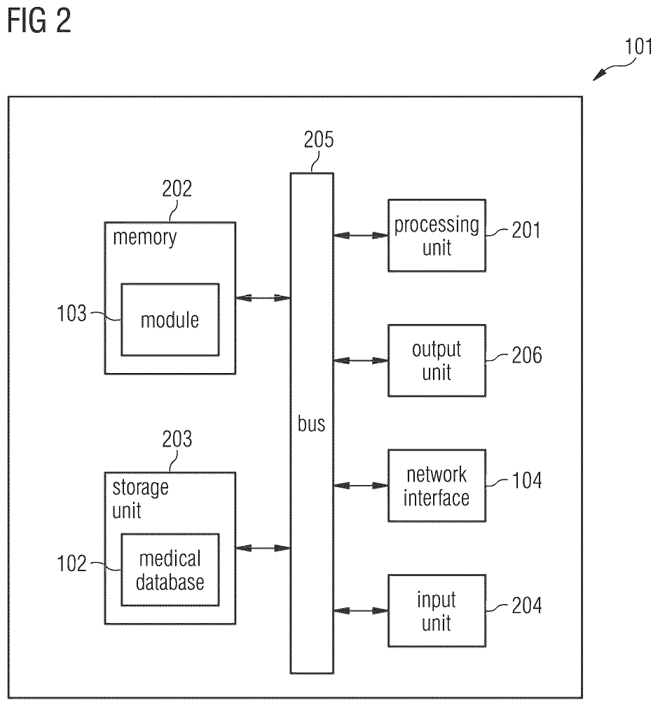

FIG. 2 is a block diagram of a data processing system 101 for growing a region in a medical image, configured to perform the processes as described herein. It is appreciated that the server 101 is an exemplary implementation of the system in FIG. 2. In FIG. 2, said data processing system 101 comprises a processing unit 201, a memory 202, a storage unit 203, an input unit 204, an output unit 206, a bus 205, and a network interface 104.

The processing unit 201, as used herein, means any type of computational circuit, such as, but not limited to, a microprocessor, microcontroller, complex instruction set computing microprocessor, reduced instruction set computing microprocessor, very long instruction word microprocessor, explicitly parallel instruction computing microprocessor, graphics processor, digital signal processor, or any other type of processing circuit. The processing unit 101 may also include embedded controllers, such as generic or programmable logic devices or arrays, application specific integrated circuits, single-chip computers, and the like.

The memory 202 may be a volatile or non-volatile non-transitory memory device. The memory 202 may be coupled for communication with said processing unit 201. The processing unit 201 may execute computer readable instructions and/or program code stored in the memory 202. A variety of non-transitory computer-readable storage media may be stored in and accessed from said memory 202. The memory 202 may include any suitable elements for storing data and machine-readable instructions executable by machine, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 201 comprises a module 103 stored in the form of machine-readable instructions on any of said above-mentioned storage media and may be in communication with and executed by the processing unit 201. When executed by the processing unit 201, the module 103 causes the processing unit 201 to grow a region in a medical image. Method steps executed by the processing unit 201 to achieve the abovementioned functionality are elaborated upon in detail in the following figures.

The storage unit 203 may be a non-transitory storage medium which stores the medical database 102. The input unit 204 may include input means such as keypad, touch-sensitive display, camera (such as a camera receiving gesture-based inputs), a port etc. capable of providing input signal such as a mouse input signal or a camera input signal. The bus 205 acts as interconnect between the processor 201, the memory 202, the storage unit 203, the input unit 204, the output unit 206 and the network interface 104. The volumetric medical images may be read into the medical database 102 via the network interface 104 or the input unit 204, for example.

Those of ordinary skilled in the art will appreciate that said hardware depicted in FIG. 1 may vary for particular implementations. For example, other peripheral devices such as an optical disk drive and the like, Local Area Network (LAN)/Wide Area Network (WAN)/Wireless (e.g., Wi-Fi) adapter, graphics adapter, disk controller, input/output (I/O) adapter also may be used in addition or in place of the hardware depicted. Said depicted example is provided for the purpose of explanation only and is not meant to imply architectural limitations with respect to the present disclosure.

A data processing system 101 in accordance with an embodiment of the present disclosure may comprise an operating system employing a graphical user interface (GUI). Said operating system permits multiple display windows to be presented in the graphical user interface simultaneously with each display window providing an interface to a different application or to a different instance of the same application. A cursor in said graphical user interface may be manipulated by a user through a pointing device. The position of the cursor may be changed and/or an event such as clicking a mouse button, generated to actuate a desired response.

One of various commercial operating systems, such as a version of Microsoft Windows™, a product of Microsoft Corporation located in Redmond, Washington may be employed if suitably modified. Said operating system is modified or created in accordance with the present disclosure as described. Disclosed embodiments provide systems and methods for processing medical images.

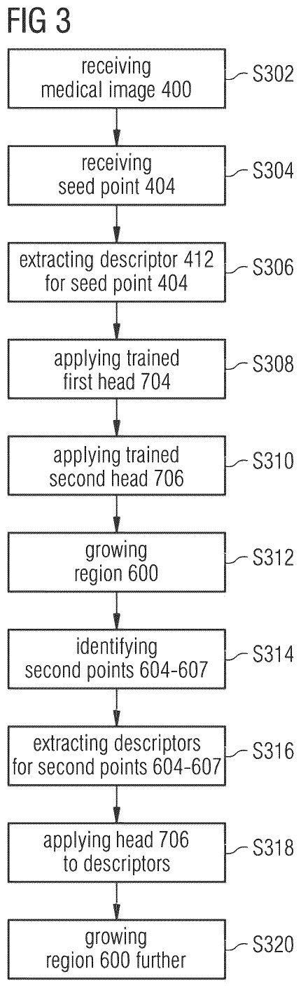

FIG. 3 illustrates a flowchart of an embodiment of a method for growing a region in a medical image.

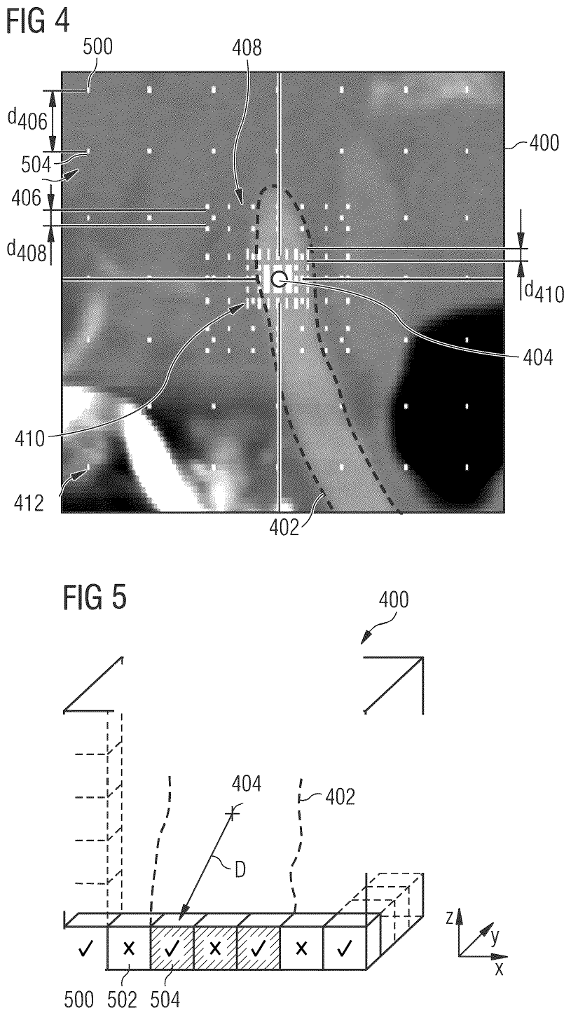

In step S302 (FIG. 3) a medical image 400 (FIG. 4) is received from the medical imaging unit 108. The medical image 400 is, for example, a volumetric medial image and may be received in the data processing systems 101 through the network interface 104 or the input unit 204.

The medical image 400 as shown in FIG. 5 may be comprised of a three-dimensional array of voxels 500, 502, 504. This array is illustrated in FIG. 5 as a cuboid seen in a perspective view. The cuboid comprises rows and columns of voxel 500, 502, 504 extending in all three dimensions x, y, z. To make FIG. 5 more readable, only some of the voxels 500, 502, 504 within the cuboid are shown.

Instead of the three-dimensional array, the method explained herein may also use a number of slices (two-dimensional arrays of pixels) which, taken together, describe a (three-dimensional) volume, or may simply use a 2D image (two-dimensional arrays of pixels). In fact, any other data structure may be used comprising values, such as intensities (e.g., in a greyscale image), and describing a two- or three-dimensional space. Any such value is termed a “pixel” (2D) or “voxel” (3D) herein. The value may be combined with information describing its three-dimensional relationship with respect to other values, or the two- or three-dimensional relationship can be inferred from the data structure, or any other source.

Returning to FIG. 4, it is shown that the medical image 400 comprises at least one organ or a portion thereof, for example a blood vessel 402. In FIG. 5, the blood vessel 402 is represented by hashed voxels 504. Voxels 500, 502 represent other tissue, outside the blood vessel 402. In both FIGS. 4 and 5, the dashed line 402 represents a boundary between the vessel tissue and the surrounding tissue.

In step S304 (FIG. 3), a seed point 404 (FIG. 4; the seed point 404 may also be referred as a “first” point) in the medical image 400 is received. The seed point 404 may be selected on the medical image 400 by a user, for example a radiologist, through a graphical user interface (GUI) using a pointer device. The GUI may be a screen 110 (FIG. 1) of the client device 107A. The pointer device may be a mouse connected to the client device 107A. The screen 110 may display the medical image 400 or portions thereof and a cursor controlled by the mouse. On the other hand, the seed point 404 may be received, for example, via the network interface 104 or the input unit 204 (FIG. 2). The seed point 404, once selected, may be represented by one or more pixels on the screen 110. The one or more pixels may be colored in red or any other color to differentiate them from the remainder of the medical image 404.

The seed point 404 is a point in the medical image 400 for which it is desired to identify the type of tissue or organ corresponding to said point. Said seed point 404 may be described through coordinates in x, y, z and may correspond to a specific voxel in the cuboid of FIG. 5. If, for example, a mouse is used to select the seed point 404, the coordinates x, y, z of the cursor, once the selection of the seed point 404 has been made, for example by clicking or pausing the cursor over the medical image 400, are transmitted, for example, via the input unit 204 to the data processing system 101.

In step S306 (FIG. 3), (first) features from the medical image 400 are extracted from a volume (3D) or an area (2D) including the seed point 404, preferably. To this end, it may be provided that voxels 500, 504 are sampled from the medical image 400. For example, the module 103 (FIG. 2) reads voxels 500, 504 from the medical image 400 contained in the medical database 102. At least one voxel 502 may be skipped between two sampled voxels 500, 504. In FIG. 5, the sampled voxels are designated with a tick, whereas skipped or not sampled voxels are designated with a cross. In the embodiment of FIG. 5, in the row of voxels defined by adjacent voxels 500, 502, 504 only every second voxel 500, 504 is sampled. The voxels 500, 504 may be sampled sequentially or in parallel.

To define which voxels are sampled and which are not, the module 103 may comprise an algorithm. Alternatively, the sampled voxels may be defined by the user via the input unit 204 or supplied via the network interface 104.

In embodiments of step S306, the voxels 500, 504 are sampled in a sparse manner. That is to say that the number of voxels sampled in the medical image 400 is less than the total number of voxels contained in the medical image. In particular, the number of sampled voxels may be less than 50%, less than 20% or less than 10% of the total number of voxels in the medical image 400 to be considered sparse. In one embodiment, the sampled voxels 500, 504 are less than 1%, preferably less than 0.1% and more preferably less than 0.01% of the total number of voxels in the volumetric medical image 400.

Alternatively, or additionally, the voxels may be sampled in a random manner. For example, a random number generator or pseudo number random generator may be used to identify voxels 500, 504 in the volumetric medical image 400 which are to be sampled and others which are not sampled.

In particular, it may be beneficial if the voxels 500, 504 are sampled in step S306 with a sampling rate per unit length, area or volume which decreases with a distance D (FIG. 5) from the seed point 404. It was found that results improve even more, when the sampling rate decreases at a nonlinear rate, in particular at the rate of an exponential, logarithmic or power function. This approach is shown in FIG. 4 using hierarchical sparse sampling. It is “hierarchical” as sampling points are arranged on two or more, in this case three 3D-grids 406, 408, 410 with different grid spacings (distance between nodes each associated with a sampling point) d406, d408, d410. The 3D grids may be nested inside each other as shown in FIG. 4, with the seed point 404 at their respective center. For example, the 3D grids are chosen with the same number of sampling points each, for example 7×7×7 sampling points 500, 504. The grid spacing d406 may equal 8 mm, d408 may equal 3 mm and d410 may equal 0.5 mm, for example. This kind of sampling balances global and local image data context. The sampled voxels 500, 502 are collectively referred to as a descriptor 412 (also termed “extracted features” herein).

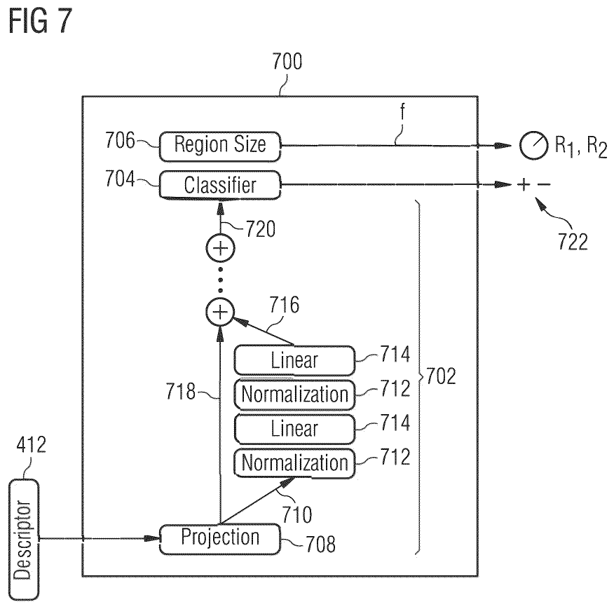

Next, a trained machine learning algorithm 700 (FIG. 7) is applied to the descriptor 412. In this case, the trained machine learning algorithm 700 comprises a trained feature extraction algorithm 702 followed by two heads 704, 706 (also termed “first machine learning algorithm” and “second machine learning algorithm” herein). The trained feature extraction algorithm 702 is a residual neural network (ResNet), for example. Each head 704, 706 is also configured as a trained neural network, for example as a ResNet, convolutional neural network (CNN), transformer, mamba or long short-term memory (LSTM). In one example, the feature extraction algorithm 702 and the two heads 704, 706 are embodied as a single neural network (e.g., of the types mentioned above).

The trained feature extraction algorithm 702 reduces, using a linear projection layer 708, the dimension of the descriptor 412 (determined as described above, for example). For instance, the descriptor 412 described above comprises 7×7×7×3 data points (voxels), equaling 1029 data points. The projection 708 has only 128 data points, for example.

The projection 708 is then (path 710 on the right) normalized (for better data convergence) and linearized, using a normalization layer 712 and linearization layer 714. The linearization layer 714 is preferably followed by a non-linear function (e.g. a swish-function to provide mostly positive values). The output from the first linearization layer 714 may be normalized and linearized again using another set of layers 712, 714. The output 716 is added to the (original) projection 708 (the path 718 representing a signal that is directly sent from a shallower block to a deeper block). These steps of normalization, linearization and addition may be repeated.

The final output 720 (features extracted from the descriptor 412 by applying the trained feature extraction algorithm 702) is input to the heads 704 and 706, respectively.

The (first) head 704 may use a binary classification algorithm (e.g., a trained neural network) to determine, depending on the final output 720, whether the tissue at the seed point 404 is a blood vessel (step S308 in FIG. 3). For example, if it is a blood vessel, the algorithm will return “1”, otherwise “0”. The binary result 722 is indicated in FIG. 7. This decision is made based on the greyscale, density, shape, pattern and possibly various other parameters found in the data of the final output 720.

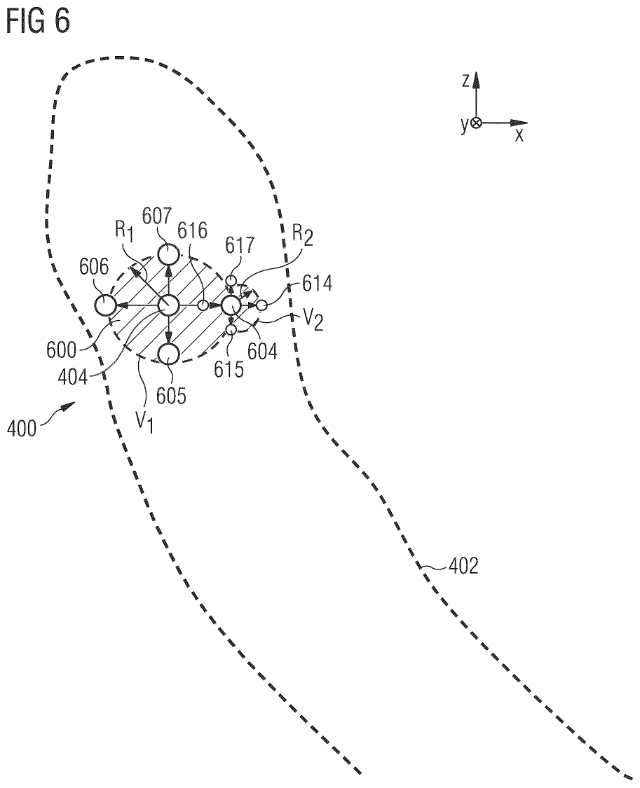

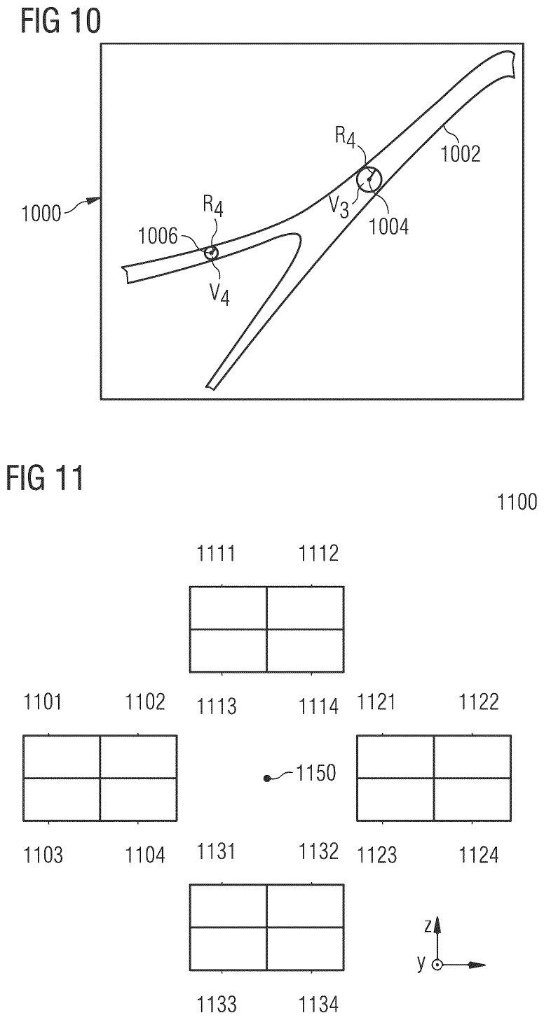

The (second) head 706 is, preferably, also a trained neural network and outputs a radius R1 (see also FIGS. 6 and 7) defining a region of confidence V1 (step S310 in FIG. 3). The region of confidence V1 is a volume within the medical image 400 which is expected to have the same tissue (blood vessel 402) as at the seed point 404 with a predefined probability. The probability can be, e.g., larger than 90%, 95%, 98%, 99% or 99.9% and depends on the training of the head 706 prior to execution as will be explained in connection with FIGS. 9 and 10 hereinafter.

R1 may be limited (cropped) to a predefined range for example 0.5 to 2 mm to prevent too much deviation in case of noisy input which could be formulated as R1=(0.5+σ (f)*1.5). In this case “f” is the output from the head 706, see FIG. 7, and σ is the sigmoid function.

In step S310 (FIG. 3), all voxels within the volume V1 are designated as belonging to the blood vessel 402. In one embodiment, the voxels are each associated with a parameter indicative of the voxels belonging to the blood vessel 402 (e.g., a binary parameter set to “1”). Pixels on the screen 110 which correspond to the voxels belonging to the blood vessel 402 are colored in, e.g., in red. Thus, in step S312 (FIG. 3) the initial red seed point 404 is grown into a red region 600 (see FIG. 6 which shows the red region 600 as shaded) in the medical image 400 (including overlaying the image 400 partially) as seen on the screen 110.

The red region 600 is to be grown further to eventually fill the entire blood vessel 402. To this end, six second points 604-607 are identified in step S314. Four of these are shown in FIG. 6. The additional two points cannot be seen as they lie in front and behind the plane of the paper. The six points 604-607 are, according to a first embodiment illustrated in FIG. 6, chosen to lie inside the volume V1, preferably, right on the surface of the sphere defined by the radius R1, and, even more preferable, in the −x, +x, −y, +y, −z, +Z direction. Advantageously, it is known for such six points 604-607 that the tissue 402 they represent corresponds, with a sufficient probability, to the blood vessel 402. According to a second embodiment, the six points 604-607 are chosen outside the volume V1 (not shown). In this case, it needs to, by way of the head 704, be checked if those points still lie within the blood vessel 402. This check may also be made in the first embodiment in regard to the second points 604-607.

Continuing with the first embodiment, (second) features are now extracted in step S316 from the medical image 400. Preferably, voxels are sampled in an analogous manner as described above in connection with the seed point 404. However, this time the obtained descriptor (not shown) is centered on the second point 604.

In step S318, the head 706 is applied to the descriptor to obtain a radius R2 (FIGS. 6 and 7), defining a (second) region of confidence V2. The radius R2 is found to be smaller than the radius R1 (to have the same confidence that all voxels within the volume V2 are within the blood vessel 402). This is due to the second point 604 being closer to the blood vessel boundary (dashed line 402) than the seed point 404.

The red region 600 on the screen 110 is subsequently grown to also include the volume V2 (step S318).

The process described in connection with the first second point 604, may be extended to all other second points 605-607. In particular, the points 605-607 may be added, by the module 103, to a processing queue which is processed by the processing unit 201. In program code, this may be written as:

R1 = estimate_region_size(I, x, y, z)
add_to_queue(I, x+R1, y, z);
add_to_queue(I, x−R1, y, z);
add_to_queue(I, x, y+R1, z);
add_to_queue(I, x, y−R1, z);
add_to_queue(I, x, y, z+R1);
add_to_queue(I, x, y, z+R1);
fill_region(I, x, y, z, R1)

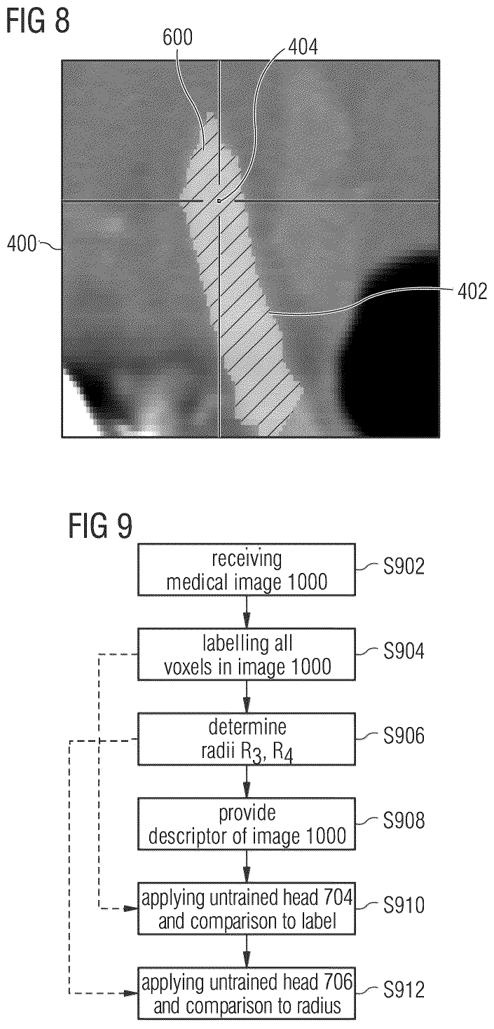

Of course, the above may be repeated in relation to third points 614-617 centered around each second point 604-607 to extend the region 600 further to completely fill the blood vessel 402 as shown in FIG. 8. The algorithm executes the full process until the user decides to stop or no other candidate points are left in the queue.

Referring to FIGS. 9 and 10, an embodiment of a method for training the machine learning algorithm 700 is explained. The machine learning algorithm 700 initially comprises the untrained feature extraction algorithm 702 followed by the two untrained heads 704, 706.

In step S902 (FIG. 9), a medical image 1000 (FIG. 10) is received. The medical image 1000 includes a blood vessel 1002. What has been explained in regard to medical images above, equally applies here.

Preferably, a trained segmentation machine learning algorithm (e.g., a CNN such as U-Net) is used to label every voxel in the medical image 1000 (step S904). The labelled image may also be referred to as a segmentation mask. Theses labels represent a first ground truth used in the training of the (classifier) head 704 in step S908 below.

Preferably, in step S906 a trained machine learning algorithm is used to determine radii R3, R4 (associated with N predefined points 1004, 1006 in the medical image 1000—the N points may lie on a suitably fine grid or correspond to some or all voxels in the medical image 1000) each encompassing a volume R3, R4 which is filled with only such voxels that lie within the blood vessel 1002. The algorithm can allow a small percentage, e.g. smaller than 1% or 0.1% of the voxels not to correspond to the blood vessel 1002 to avoid the algorithm being oversensitive. The radii R3, R4 associated with points in the medical image 1000 represent a second ground truth used in step S912 below.

Next, features are extracted from the image 1000 to provide a descriptor (step S908). What has been explained in regard to descriptors above, equally applies here. Preferably, the portion of the medical image 1000 which shows the blood vessel 1002 is oversampled. This results in the training data containing more positive samples (“blood vessel”) to compensate for the fact that blood vessels typically occupy only a small part of the medical image.

This is followed in step S910 by applying a first machine learning algorithm (composed of the untrained feature extraction algorithm 702 and the untrained head 704) to the descriptor to obtain a classification of tissue (in this case, blood vessel 1002 present: yes or no?) at a first point 1004 in the medical image 1000, comparing the obtained classification to the first ground truth, and updating the first machine learning algorithm (i.e., generating a training signal and updating weights and biases) depending on the comparison.

This is followed in step S912 by applying a second machine learning algorithm (composed of the untrained feature extraction algorithm 702 and the untrained head 706) to the descriptor (which could be preferably different from the descriptor used in step S910) to obtain a region of confidence relative to the first point, the region of confidence being a region in which the tissue is expected to be the same as at the first point, comparing the region of confidence to the second ground truth, and updating the second machine learning algorithm (i.e., generating a training signal and updating weights and biases) depending on the comparison.

Steps S908-S912 are repeated for N−1 points 1006 or voxels in the medical image 1000. N may be larger than 100, 1000, 10000 or 10000, for example. Then, steps S902-S912 are repeated for a number of medical images, for example more than 100, 1000, 10000 or 10000 medical images.

FIG. 11 shows a further embodiment of a method of region growing. In this case, a block-by-block growing is implemented.

FIG. 11 shows a medical image 1100. What has been elaborated above regarding medical images, equally applies here. A seed point 1150 is selected. Six blocks (two are not shown for being positioned before and behind the plane of the paper) with four voxels 1101-1104, 1111-1114, 1121-1124, 1131-1134 each are identified. A trained machine learning algorithm (e.g. segmentation algorithm) is used to determine whether the voxels in each block should by added to the growth region or not. This determination (e.g., including labelling) is done, preferably, for all voxels in one block at the same time. In one embodiment, this determination could be made for all six blocks at the same time. In a next step, another set of new six blocks around each of the previous six blocks is selected and the voxels within each new block are evaluated. Also, by this method, region growing can be accelerated, compared to the case where neighboring voxels are labeled sequentially to decide whether or not they should be added to the growth region.

Although the present framework has been described in accordance with preferred embodiments, it is obvious for the person skilled in the art that modifications are possible in all embodiments.

### REFERENCE NUMERALS

100 system
101 computer-implemented device
102 medical database
103 module
104 network interface
105 network
107A-107N client device
108 medical imaging unit
110 screen
201 processing unit
202 memory
203 storage unit
204 input unit
205 bus
206 output unit
400 medical image
402 blood vessel
404 seed point
406, 408, 410 grids
412 descriptor
500, 502, 504 voxels
600 growing region
604-607 second points
614-617 third points
700 trained machine learning algorithm
702 trained feature extraction algorithm
704, 706 heads
708 projection layer
710 path
712 normalization layer
714 linearization layer
716 output
718 direct link
720 final output
722 binary parameter
1000 image
1002 blood vessel
1004 first point
1006 Nth point
1100 medical image
1101-1134 blocks
d406, d408, d410 grid spacing
D distance
f output
R1-R4 radii
S302-S320 method steps
S902-S912 method steps
V1-V4 confidence regions/volumes
x, y, z directions

1. A computer-implemented method for growing a region in a medical image, the method comprising:
receiving the medical image;
receiving a seed point in the medical image;
extracting first features from the medical image;
applying a trained first machine learning algorithm to the first features to obtain a classification of tissue at the seed point;
applying a trained second machine learning algorithm to the first features to obtain a first region of confidence relative to the seed point, the first region of confidence being a region in which the tissue is expected to be the same as at the seed point; and
growing, in a graphical user interface, the region in the medical image from the seed point to include the first region of confidence.

2. The method of claim 1, further comprising:
identifying at least one second point in the medical image depending on the first region of confidence;
extracting at least second features from the medical image;
applying the trained second machine learning algorithm to the at least second features to obtain a second region of confidence relative to the at least one second point, the second region of confidence being a region in which the tissue is expected to be the same as the at least one second point; and
growing, in the graphical user interface, the region further to include the second region of confidence.

3. The method of claim 2, wherein the first region and the second region of confidence are different in size.

4. The method according to claim 2, wherein at least four or six second points are identified.

5. The method according to claim 2, further comprising:
comparing the first or second region of confidence to a predefined threshold value; and
limiting the first or second region of confidence to the predefined threshold value depending on the comparison.

6. The method according to claim 2, wherein the at least one second point lies within the first region of confidence.

7. The method according to claim 6 wherein each second point lies within the first region of confidence.

8. A computer-implemented training method, comprising:
a) receiving a medical image;
b) extracting features from the medical image to obtain extracted features;
c) applying a first machine learning algorithm to the extracted features to obtain a classification of tissue at a first point in the medical image, comparing the classification to a first ground truth, and updating the first machine learning algorithm depending on the comparison;
d) applying a second machine learning algorithm to the extracted features to obtain a region of confidence relative to the first point, the region of confidence being a region in which the tissue is expected to be the same as at the first point, comparing the region of confidence to a second ground truth, and updating the second machine learning algorithm depending on the comparison; and
e) repeating steps b) to d) for N−1 points in the medical image, with N designating a total number of predefined points in the medical image.

9. The method according to claim 8, further comprising applying a segmentation machine learning algorithm to the medical image or the extracted features to determine the first ground truth, the second ground truth, or a combination thereof.

10. The method according to claim 9, wherein the second ground truth is determined by identifying, through segmentation, a number or volume of pixels or voxels representing the same tissue as at a first or Nth point.

11. The method according to claim 8, wherein the extracted features comprise independent samples of data.

12. The method according to claim 11 wherein the independent samples of data include a unique descriptor, respectively.

13. The method according to claim 8, wherein extracting the features from the medical image comprises sampling pixels or voxels from the medical image, wherein at least one voxel is skipped between two sampled pixels or voxels.

14. The method according to claim 8, wherein extracting the features from the medical image comprises sampling pixels or voxels with a sampling rate per unit length, area or volume which decreases with a distance of a respective pixel or voxel from a seed point, first point, second point or Nth point.

15. The method according to claim 14 wherein the sampling rate decreases at a non-linear rate.

16. The method according to one of claim 8, wherein extracting the features from the medical image comprises oversampling a region of interest.

17. The method according to claim 8, wherein the extracted features are projected into a fixed dimension to obtain projected features.

18. The method according to claim 17, wherein the projected features are normalized or linearized to obtain normalized or linearized features, wherein the normalized or linearized features are added to the projected features to obtain resulting features.

19. A device for growing a region in a medical image, the device comprising:
one or more processing units; and
a non-transitory memory device communicatively coupled to the one or more processing units, the non-transitory memory device stores computer readable program code, the one or more processing units being operative with the computer readable program code to grow a region in a medical image by performing steps including
receiving the medical image,
receiving a seed point in the medical image,
extracting first features from the medical image,
applying a trained first machine learning algorithm to the first features to obtain a classification of tissue at the seed point,
applying a trained second machine learning algorithm to the first features to obtain a first region of confidence relative to the seed point, the first region of confidence being a region in which the tissue is expected to be the same as at the seed point, and
growing, in a graphical user interface, the region in the medical image from the seed point to include the first region of confidence.

20. One or more non-transitory computer-readable media embodying instructions executable by machine to perform operations for growing a region in a medical image, comprising:
receiving the medical image;
receiving a seed point in the medical image;
extracting first features from the medical image;
applying a trained first machine learning algorithm to the first features to obtain a classification of tissue at the seed point;
applying a trained second machine learning algorithm to the first features to obtain a first region of confidence relative to the seed point, the first region of confidence being a region in which the tissue is expected to be the same as at the seed point; and
growing, in a graphical user interface, the region in the medical image from the seed point to include the first region of confidence.
